(19) United States
(12) Patent Application Publication
(10) Pub. No.: US 2020/0170362 A1
(43) Pub. Date: Jun. 4, 2020

(54) INTERCHANGEABLE BAG SYSTEM

(71) Applicant: Wuchen Xie, Irvine, CA (US)

(72) Inventor: Wuchen Xie, Irvine, CA (US)

(21) Appl. No.: 16/702,387

(22) Filed: Dec. 3, 2019

Related U.S. Application Data
(60) Provisional application No. 62/774,705, filed on Dec. 3, 2018.

(51) Int. Cl. A45C 3/08; A45C 13/08; A45C 13/10; A45C 13/12; A45C 13/18; A45C 13/26; A45C 15/00

(52) U.S. Cl. CPC A45C 3/08; A45C 13/08; A45C 13/103; A45C 13/1069; A45C 13/1084; A45C 13/1092; H02J 7/35; A45C 13/126; A45C 13/18; A45C 13/26; A45C 15/00; A45C 2013/1015; A45C 13/123

(57) ABSTRACT

An interchangeable bag system and method of using the bag. The bag includes a base which forms an interior compartment of the interchangeable bag system, a cover, sets of complementary retention elements and at least one set of interlocking mechanism. The retention elements help secure the interchangeable covers to the base of the bag. The interlocking mechanism ensures that the cover is securely attached to the base of the bag. The interchangeable cover covers the entire surface area of the bag and is securely attached to the base while allowing a user to access the interior compartment of the bag.

### CROSS-REFERENCE TO RELATED APPLICATIONS

This application claims priority to U.S. Provisional. No. 62/774,705, filed on Dec. 3, 2018, which is hereby incorporated by reference in its entirety. This application also contains subject matter similar to that disclosed in U.S. Design patent application No. 29/692,852, filed on May 29, 2019 entitled “Interchangeable Bag with Cover”, which is hereby expressly incorporated by reference as part of the present disclosure.

### BACKGROUND OF THE INVENTION

### 1. Field of the Invention

The field of the disclosure is handbags, purses, and similar containers for the carriage of personal articles in general and various embodiments of a purse or purses having interchangeable covers and handles therewith so that the covers and handles are interchangeable between purses specifically.

### 2. Description of the Related Art

Bags and purses are an important part of fashion and wardrobe. And people often want to change the appearance of their bags to suit a certain outfit. As a result, carrying bag manufacturers continue to introduce new styles to meet the buying public's desire for these items. Buying many bags can be cost prohibitive and moving one's items from one bag to another can be very time consuming and people are more prone to forgetting important items when moving belongings from one bag to the next. In addition, with the rise of fast fashion landfills are filled with personal belongings that users only use once and want to change.

Several trials have been made to develop an interchangeable bag system and attempted to create versatile bags. One such versatile handbag is shown in U.S. Pat. No. 4,112,991 to Barbaresi. This bag shows a rigid, transparent basket-like frame and an interchangeable soft fabric bag inside it. The handles of the handbag are connected through the frame and bag. The bag folds over the top of the frame. The bags can be interchanged to change the look of the handbag.

Another interchangeable handbag is shown in U.S. Pat. No. Des. 164,621 to Bienen. This patent shows an inner handbag with an interchangeable cover. U.S. Pat. No. 6,003,573 to Owens shows an interchangeable purse assembly in which a soft inner liner can be used with one of several different outer handbag components. U.S. Pat. No. 6,422,278 to Grogan shows a pair of nested handbags that can also function as independent units. U.S. Pat. No. 4,811,769 to Phares discloses a purse insert that can be transferred from one purse to another. U.S. Pat. No. 4,907,633 to Eckstein discloses a handbag assembly in which a variety of outer decorative coverings can be attached to the main bag.

These handbags suffer from several significant disadvantages. Specifically, a user must cram the lifting straps into a gap located between the inner pouch and the outer bag when the inner pouch is fastened to the outer bag or must change the lining from one bag to the next risking spilling the belongings contained in the liners, or having the liners rip due to having too many items within a liner or due to tear and wear from removing the liners from one bag to the next.

Thus, what is needed in the marketplace is an interchangeable carrying bag system that permits users to use a wide variety of different covers and handles yet advantageously streamline the base bag conversion process without negatively affecting the system's aesthetics. In addition, there is a need for an innovative, fashionable and sustainable tech fashion solution for bags, not to mention ethically responsible.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The embodiment may seek to satisfy one or more of the above-mentioned desires. Although the present embodiment may obviate one or more of the above-mentioned desires, it should be understood that some aspects of the embodiment might not necessarily obviate them.

Thus, there is still a need for a simple interchangeable bag system and method of use.

Currently, there are no useful alternatives that effectively address those problems. As will be disclosed below, the present disclosure addresses these needs and covers an interchangeable bag system and method to use the interchangeable bag to prevent these inconveniences and solve these issues.

### SUMMARY OF THE INVENTION

In one aspect, the present invention is embodied as an interchangeable bag system and method of using the bag. The bag includes a base which forms an interior compartment of the interchangeable bag system, a cover, sets of complementary retention elements and a set of interlocking mechanism. The retention elements help secure the interchangeable cover or covers to the base of the bag. The interlocking mechanism ensures that the cover is securely attached to the base of the bag. The interchangeable cover covers the entire surface area of the bag and is securely attached to the base while allowing a user to access the interior compartment of the bag.

In one embodiment of the present disclosure, an interchangeable bag system is provided with a separable base, a main cover and additional side covers which allow easy conversion into a variety of different styles and configurations. Specifically, the base and the main cover and side covers are coupled together thanks to retention elements and/or interlocking mechanisms.

In one embodiment, the present disclosure is embodied as an interchangeable bag system including a base having a rear wall and a front wall opposite the rear wall wherein the base forms an interior compartment of the interchangeable bag system. The interchangeable bag system also includes a cover including a rear flap and a front flap, and at least one set of complementary retention elements including a first portion of the complementary retention element and a second portion of the complementary retention element where the first portion of the complementary retention element is coupled to the base and the second portion of the complementary retention element is coupled to the cover and where the at least one set of complementary retention elements is removably attaching the base to the cover and wherein the cover covers an entire surface area of the base. The interchangeable bag system also includes at least one set of interlocking mechanism comprising an opening located on the base and a complementary interlocking attachment located on the rear flap of the cover such that when the at least one set of interlocking mechanism is engaged, the rear flap of the cover is securely attached to the base and the front flap is removably couplable to the front wall of the base with the at least one set of complementary retention elements. Here a user can open the front flap to access the interior compartment of said interchangeable bag system while the rear flap remains securely attached to the rear wall.

In another embodiment, the disclosure is embodied as an interchangeable bag system the base also includes a peripheral wall connecting said rear wall to said front wall, and the cover further comprises at least one peripheral cover. The first portion of the set of complementary retention element is coupled to the peripheral wall and the second portion of the set of complementary retention element is coupled to the at least one peripheral cover such that the peripheral wall is removably couplable to the at least one peripheral cover.

In an alternative embodiment, the interchangeable bag system has at least one set of complementary retention elements such as a set of magnets including a magnet and a gripper and such that at least one of the magnet and the gripper is located within said base sandwiched within at least one of the front wall, rear wall and the peripheral wall.

In another embodiment, the interchangeable bag system has a set of complementary retention elements which can be any or a combination of: a complementary set of magnets, a complementary set of hooks and loops, a complementary set of lace and loops, a complementary set of snap-on attachments, a complementary set of a latch and lock, a complementary set of buttons, a complementary set of twist and lock and opening, a complementary set of hook and eye, a tuck lock, a release buckle, a clasp, a latch, a zipper and/or pin.

In yet another embodiment, the interchangeable bag system includes at least one set of interlocking mechanism. The set of interlocking mechanism is one of a twist-lock mechanism, a snap-fit, a hook and eye, a buckle set, a clap set, a latch set, a latch and a lock and/or a combination thereof.

In an alternative embodiment, the interchangeable bag system also includes an interchangeable handle removably coupled to either the base or the cover.

In one particular embodiment, the interchangeable bag system also includes two or more legs coupled to a bottom portion of the cover or the base such that the bag system can rest on a surface or external flat surface. Where the two or more legs coupled to a bottom portion of the base, the cover includes one or more openings on a bottom side of the cover adapted to fit the legs through the one or more openings such that the interchangeable bag system rests on a surface.

In one embodiment, the interchangeable bag system also includes at least one set of complementary retention elements which are electronic retention elements controllable via an external device such as a mobile phone, a tablet or a remote controller.

In an alternative embodiment, the base of the interchangeable bag system also includes a battery adapted to be charged by a remote wireless charging station, a cord attached to an external power outlet, solar panels or thanks to electronic retention elements. Here, the battery also helps power any or all of the additional electronic attachments such as the electronic retention elements, global positioning system, speaker, screen or any other electronic addition to the interchangeable bag system.

In another embodiment, interchangeable bag system's cover also includes a solar panel adapted to be charged by a solar power and such that solar panel can charge a charger, a battery, and/or a rechargeable battery within the bag system, electronic retention elements, global positioning system, speaker, and/or a screen.

In one embodiment, the interchangeable bag system has a cover which also includes a touch screen facing outwardly such that a user can connect a remote mobile phone or a remote tablet to the touch screen. The screen on the cover of the interchangeable bag system is adapted to mirror a content displaying on the remote mobile phone or the remote tablet.

In another embodiment, the interchangeable bag system has a cover which includes at least one speakerphone connectable to an external device and such that a user can select a music from the external device and the music plays on the cover speakerphone.

In yet another embodiment, the interchangeable bag system has a cover which includes at least one speakerphone connectable to an external device and such that a user can select a music from the external device and the music plays on the cover speakerphone. The system also includes an electronic screen coupled to the cover with a touch screen facing outwardly such that a user can connect a remote mobile phone or a remote tablet to the touch screen and the screen on the cover of the interchangeable bag system is adapted to mirror a content displaying on the remote mobile phone or the remote tablet. In an alternative embodiment, the interchangeable bag system includes both a speakerphone and an electronic screen such that a user can sync both video and audio and have the synced audio and video play on the cover of an interchangeable bag system.

In an alternative embodiment, the interchangeable bag system has a base which also includes a global positioning system which can be attached to the base or the cover or both. In a particular embodiment, the GPS is coupled to a portion of the base adapted to connect to an external device such that a user can locate a position of the interchangeable bag system.

In some embodiments, the interchangeable bag system has a complementary base and cover which can be spherical, rectangular, semi-circular, heart-shaped, bucket-shaped and/or polygonal.

The present disclosure is embodied in one method of changing an outer look of an interchangeable bag comprising the steps of attaching an interchangeable bag cover to an interchangeable bag base by securing a portion of the interchangeable bag cover to a portion of interchangeable bag base with an interlocking mechanism, placing the interchangeable bag cover on the interchangeable bag base such that the cover remains secured to the base with at least one set of retention elements and such that the bag cover remains securely attached to one side of the bag base, and the bag cover is removably coupled to another side of the bag base, and attaching a handle to the interchangeable bag.

In an alternative embodiment, the present disclosure is embodied in a method of changing an outer look of an interchangeable bag comprising also comprising the steps of attaching a handle cover onto the handle and where a user can change at least one side of the interchangeable bag by attaching a side cover onto a side portion of the bag base. In yet another embodiment, the method also includes the steps of providing an electronic screen on the bag wherein a user can connect a remote device such as a mobile phone or tablet to the interchangeable bag electronic screen and change a display of the electronic screen. In yet another embodiment, the method also includes the steps of providing a speaker on the bag wherein a user can connect a remote device such as a mobile phone or tablet to the interchangeable bag electronic screen and play music on the speakerphone attached to the bag. In an another embodiment where the bag includes an electronic screen and a speaker, a user can sync both the music and screen display to show on the cover of a bag.

In one embodiment, the interchangeable bag system also includes a fingerprint unlocking device such that a user can unlock the bag system through fingerprint recognition.

In an alternative embodiment, the method also includes the steps of securing the bag cover to the bag base by controlling a set of electronic retention elements via a remote device such as a mobile phone or tablet.

In another embodiment the method also includes the steps of the interchangeable bag with a global positioning system and locating a position of the interchangeable bag by connecting a remote device such as a mobile phone or tablet to the interchangeable bag global positioning system.

Before explaining the various embodiments of the invention in detail, it is to be understood that the invention is not limited in its application to the details of construction and to the arrangements of the components set forth in the following description or illustrated in the drawings. Rather, the invention is capable of other embodiments and of being practiced and carried out in various ways. Also, it is to be understood that the terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

For a better understanding of the invention, its operating advantages and the specific objects attained by its uses, reference should be made to the accompanying drawings and descriptive matter in which there are illustrated preferred embodiments of the invention.

Various objects, features, aspects and advantages of the present embodiment will become more apparent from the following detailed description of embodiments of the embodiment, along with the accompanying drawings in which like numerals represent like components.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is an exploded front perspective view of an embodiment of an interchangeable bag system.

FIG. 2 is an exploded rear perspective view of FIG. 1.

FIG. 3 is an assembled perspective view of an embodiment of an interchangeable bag system.

FIG. 4 is an exploded front view of an embodiment of an interchangeable bag system.

FIG. 5 is an assembled front view of FIG. 4.

FIG. 6 is a top view of an embodiment of an interchangeable bag system.

FIG. 7 is a bottom view of an embodiment of an interchangeable bag system.

FIG. 8 is an exploded side view of an embodiment of an interchangeable bag system.

FIG. 9 is an assembled side view of an embodiment of an interchangeable bag system.

FIG. 10 is an exploded perspective view of an embodiment of an interchangeable bag system showing electronic retention elements with a battery, a charger and a global positioning system.

FIG. 11 is an assembled perspective view of an embodiment of an interchangeable bag system showing an electronic screen on the cover of the bag.

FIG. 12 is an assembled perspective view of an embodiment of an interchangeable bag system with solar panels and a charger.

FIG. 13 is an assembled perspective view of an embodiment of an interchangeable bag system with electronic screens and speakerphones.

FIG. 14 is an exploded front perspective view of an embodiment of an interchangeable bag system.

FIG. 15 is an exploded front perspective view of an embodiment of an interchangeable bag system.

FIG. 16 is an exploded bottom perspective view of an embodiment of an interchangeable bag system with legs.

FIG. 17 is a perspective view of some embodiments of the bases of an interchangeable bag system.

FIG. 18 is a perspective view of some embodiments of the covers of an interchangeable bag system.

FIG. 19 is a perspective view of some embodiments of the peripheral covers or side covers of an interchangeable bag system.

FIG. 20 is a perspective view of another embodiment of an interchangeable bag system.

The same elements or parts throughout the figures of the drawings are designated by the same reference characters, while equivalent elements bear a prime designation.

### DETAILED DESCRIPTION OF THE INVENTION

The embodiment and various embodiments can now be better understood by turning to the following detailed description of the embodiments, which are presented as illustrated examples of the embodiment defined in the claims. It is expressly understood that the embodiment as defined by the claims may be broader than the illustrated embodiments described below.

Many alterations and modifications may be made by those having ordinary skill in the art without departing from the spirit and scope of the embodiment. Therefore, it must be understood that the illustrated embodiment has been set forth only for the purposes of example and that it should not be taken as limiting the embodiment as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

The words used in this specification to describe the embodiment and its various embodiments are to be understood not only in the sense of their defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are set forth, but all equivalent structure, material or acts for performing the same function in the same way to obtain the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

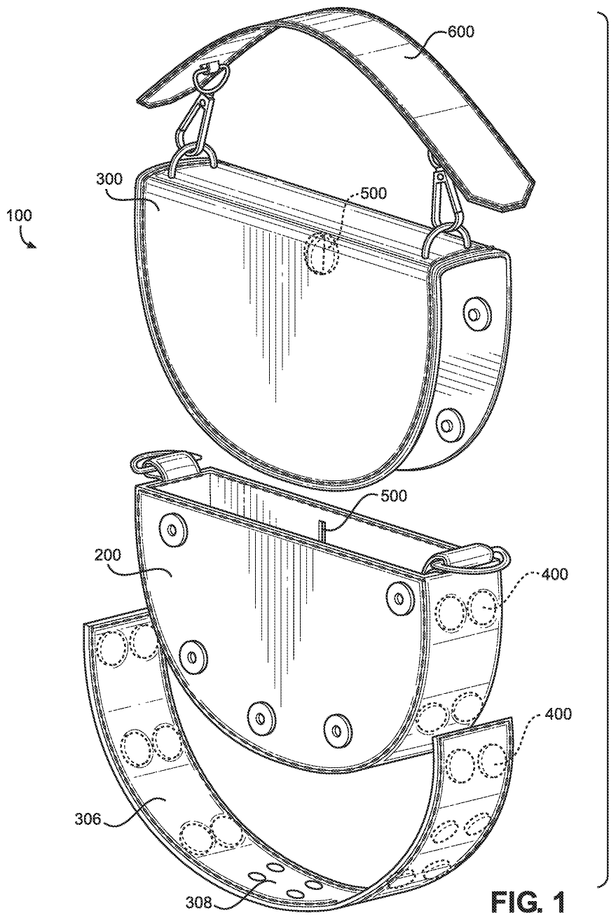

Referring now to the drawings and the characters of reference marked thereon, FIG. 1 shows an exploded front perspective view of an embodiment of an interchangeable bag system. In this embodiment, the interchangeable bag system 100 includes a base 200, a cover or main cover 300, a peripheral cover 306 or side cover 306, a handle 600 which is also interchangeable, at least one set of complementary retention elements 400 and at least one set of interlocking mechanism 500.

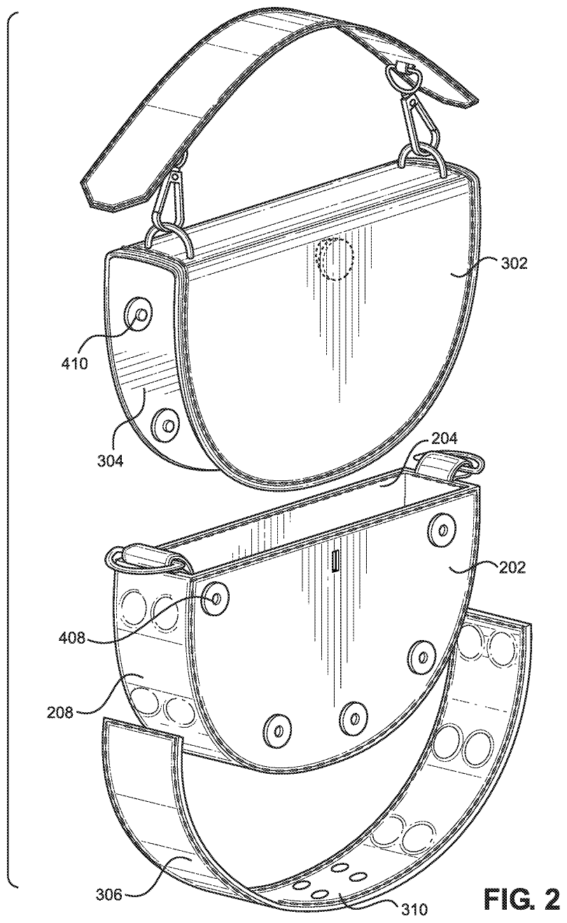

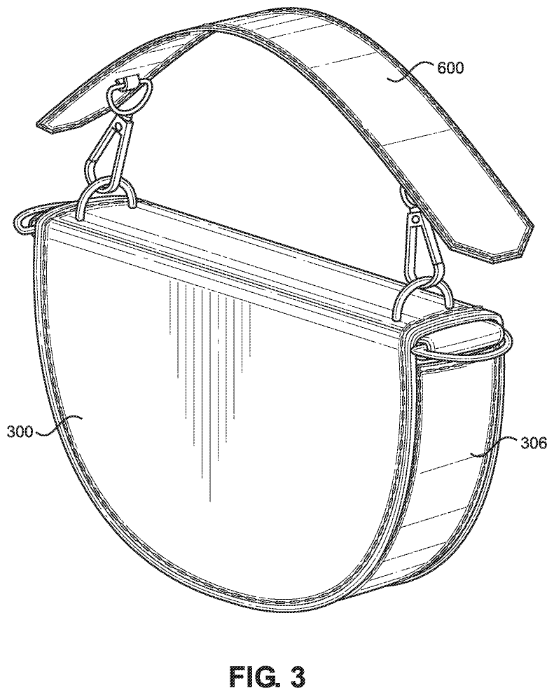

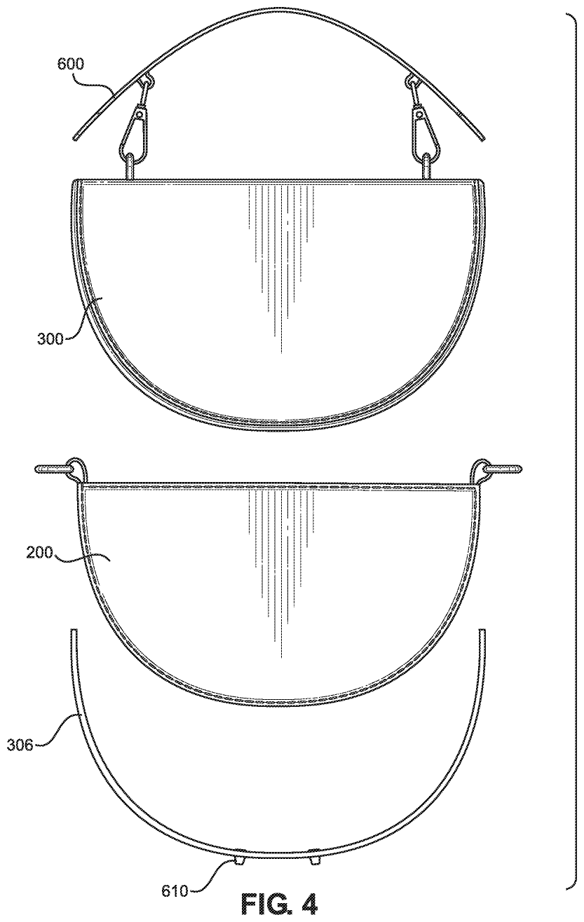

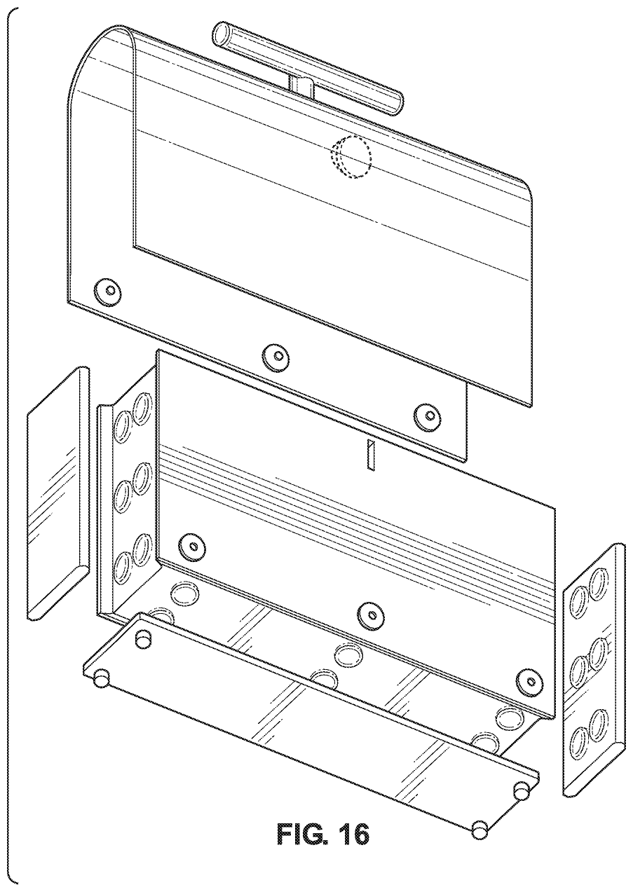

Referring to FIG. 1 through 4 and FIG. 14 through 16, an interchangeable bag system 100 includes a base 200 which has a rear wall 202 and a front wall 204 opposite the rear wall. While in shapes such as a spherical interchangeable bag system, the base only includes a front and rear wall 204 and 206, in other embodiments such as a rectangular base bags 214, semi-circular 216 or other polygonal shapes with more than two sides, the base 200 also includes other sides referred to as peripheral walls 208. The interior of the base of the bag forms an interior compartment 206 where a user can place their belongings. One advantage of the current interchangeable bag system is that a user does not need to move all their belongings from one bag to another to change look, but rather can keep all their belongings in the interior compartment of the bag system 206 and just change covers 300 and/or handles 600 to change the entire look of the bag.

FIG. 1 through 4 and FIG. 14 through 16 also show an interchangeable bag system 100 with a cover 300 or main cover 300 which includes a rear flap 302 and a front flap 304. The cover 300 is attachable to the base 200 thanks to one or more sets of complementary retention elements 400. These sets of complementary retention elements 400 include two complementary portions: a first portion of the complementary retention element 402 and a second portion of the complementary retention element 404. The two portions are complementary and can be two portions of a magnet such as a magnet 408 and a gripper 410, or two part of magnets.

While in this embodiment, the sets of complementary retention elements are shown as magnets, in other embodiments, the sets of complementary retention elements can be sets of magnets, a complementary set of hooks and loops, a complementary set of lace and loops, a complementary set of snap-on attachments, a complementary set of a latch and lock, a complementary set of buttons, a complementary set of twist and lock and opening, a complementary set of hook and eye, a tuck lock, a release buckle, a clasp, a latch, a zipper and/or a pin.

Where the sets of complementary retention elements are lace and loops, a user has to lace the lace portion to the loops to attach the base 200 to the cover 300 just as they would when lacing shoes or a corsage to keep the base and cover together. Where the sets of complementary retention elements are magnets, the user can simply press the cover 300 onto the base 200 to change the outer look of a bag. Where a bag includes peripheral walls 208 such as the ones shown in FIG. 1 through 4 and FIG. 14 through 16, a user can change the entire outer look of a bag by attaching the cover 300 or main cover 300 to the base of the bag 200 and attaching peripheral covers 306 to the peripheral walls 208 to cover an entire outer surface area of the interchangeable bag system.

While FIG. 1 through 4 and FIG. 14 through 16 show an interchangeable bag system with magnets as sets of complementary retention elements 400, the sets of complementary retention elements can be a combination of one or more of magnets, sets of hooks and loops, sets of lace and loops, sets of snap-on attachments, sets of a latch and lock, sets of buttons, a sets of twist and lock and opening, sets of hook and eye, a tuck lock, a release buckle, a clasp, a latch, a zipper and/or a pin. In the case of buttons or snap-on attachments, the user simply needs to attach the button or snap on the cover to the base to change the look of a bag. In the case of other complementary sets of retention elements, the user can press the hook and loops together. The hook and loops can be micro hooks and loops such as Velcro®, or mechanical hooks and loops where the hook needs to be opened then attached to the loop. Similarly, for sets of a latch and lock, sets of buttons, a sets of twist and lock and opening, sets of hook and eye, a tuck lock, a release buckle, a clasp, a latch, a zipper, a pin, and/or any other mechanical retention elements a user has to manually engage those retention means.

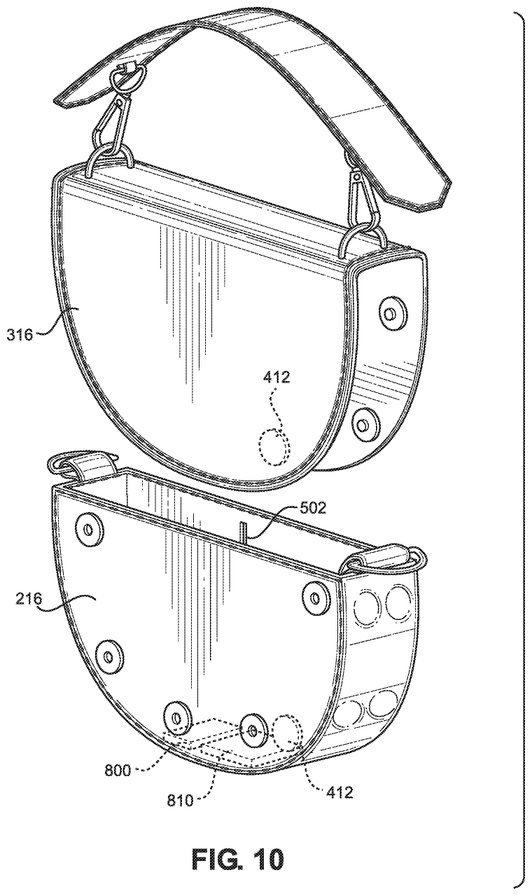

In one embodiment such as the one depicted in FIG. 10, the sets of retention elements can be electronic retention elements 412 controllable via an external device such as a mobile phone, a tablet or a remote controller. In some embodiments, the sets of retention elements can be just electronic retention elements 412 whereas in other embodiments, the sets of retention elements can be both mechanical retention elements as discussed above in paragraph [0057].

When an interchangeable bag system uses electronic retention elements 412, those electronic retention elements can be charged via a cord connecting to a remote power outlet, a remote wireless charging station, or thanks to a rechargeable battery located within the interchangeable bag system either within the base 200, the cover 300 or handles 600. In other embodiments, the interchangeable bag system also includes a solar panel 820 which is powered by solar power. In yet another embodiment, the interchangeable bag system includes a combination of cord adapter to charge using a cord connecting to a remote power outlet, a remote wireless charging station, a rechargeable battery located within the interchangeable bag system and/or a solar panel 820 which is powered by solar power. In another embodiment, the electronic retention elements transfer power from the battery to electronic elements on the cover such as an electronic screen 700, a speakerphone 710 or a global positioning system 800 or a combination thereof.

In another embodiment, the electronic retention elements can transfer power from the battery to the cover, or from the cover to the battery. The batter is also chargeable through electronic retention elements. In yet another embodiment, the base 200 includes a battery 810 adapted to be charged by a remote charging station or via a cord attached to the interchangeable bag system.

In yet another embodiment, the interchangeable bag system further comprises a solar panel 820 adapted to be charged by a solar power. This solar panel 820 charged by a solar power provides power to any electronic element within the interchangeable bag system such as electronic retention elements, a speakerphone, an electronic screen 700 and/or a GPS.

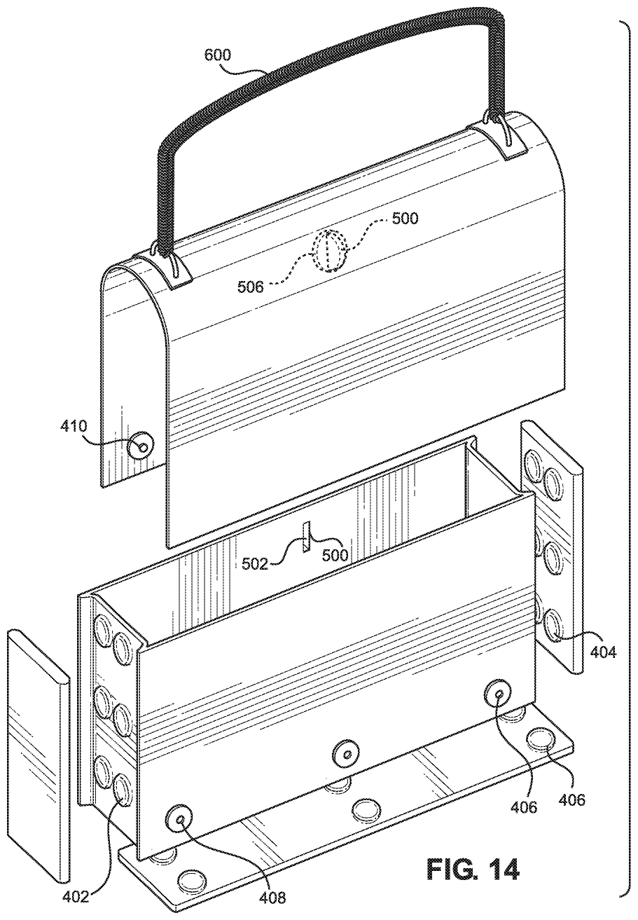

FIG. 14 through 16 show a rectangular embodiment of the present disclosure. The base 200 is a rectangular base 214 while the cover 300 is a rectangular shaped cover 314. In this embodiment, the interchangeable bag system includes more than one peripheral wall 208. The peripheral wall here 208 extends over 3 sides of the base 214. More than one peripheral cover 306 are adapted to cover the entire outer surface area of the base 200 or in this particular case rectangular base 214. A user can mix and match various styles of the cover 314 and peripheral covers 306 or can use the same style of covers for the main cover 300 and peripheral covers 306.

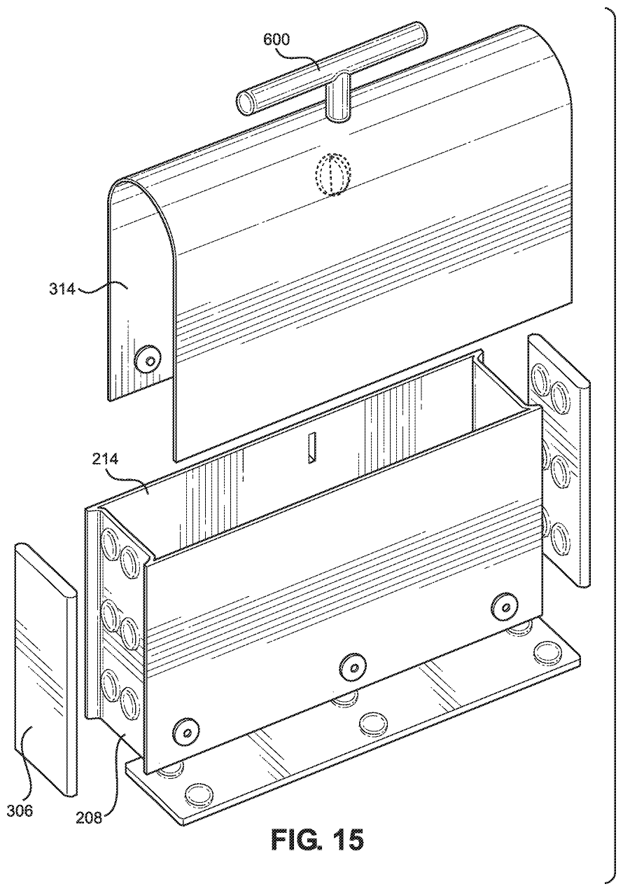

In one embodiment such as the ones depicted in FIG. 1 or FIG. 15, the interchangeable bag system includes a base 200 and a cover 300. The base is removably attached to the cover thanks to complementary sets of retention elements 400. The base includes a rear wall 202 and a front wall 204 directly opposite and spaced away horizontally from the rear wall 204. The rear wall 202 and the front wall 204 are connected via a peripheral wall 208. In FIG. 1, the peripheral wall 208 is one semi-circular peripheral wall whereas in FIG. 14, the peripheral wall 208 is three continuous peripheral walls forming a U-shape with corners. The corners can be straight edges as depicted in FIG. 14 or rounded edges.

In these embodiments such as the ones depicted in FIG. 1 or FIG. 14, the base includes a front wall, a rear wall and a peripheral wall and also includes two faces on each wall. An inner face forming part of the interior compartment 206 and an outer face on the other side of the wall facing outwardly. The outer face on the outer side of the wall connects to a removably couplable cover thanks to at least one set of complementary retention elements 400.

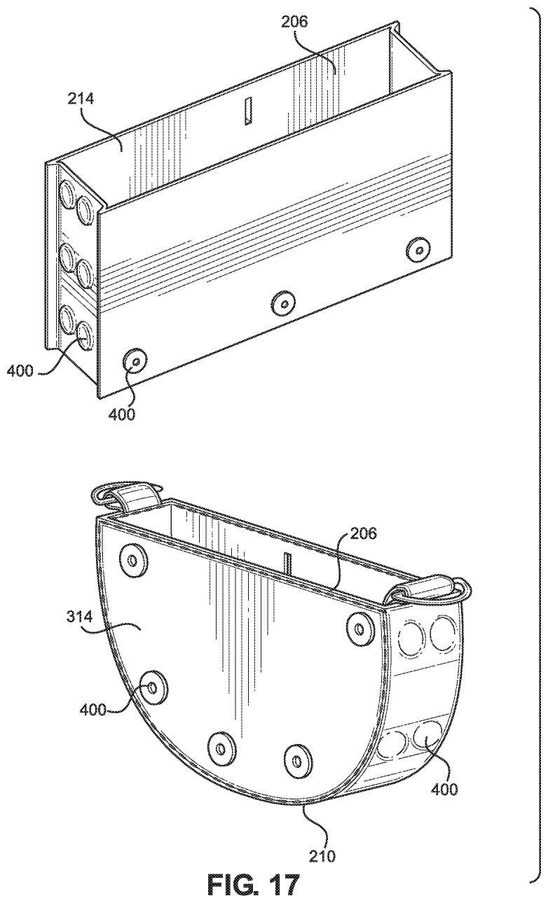

FIG. 17 shows bases 200 of the present disclosure with sets of complementary retention elements which are both located on outer face of the walls, as well as complementary retention elements located within the peripheral walls 208. While FIG. 17 shows complementary retention elements located within the wall on the peripheral walls and external complementary retention elements on the front and rear walls, each one of the front wall, rear wall and peripheral wall can include external complementary retention elements, internal complementary retention elements within the walls or a combination thereof.

FIGS. 1 and 15 also show an interchangeable bag system where the cover 300 includes a rear flap 302 and a front flap 304. While spherical embodiments of the bag only include a front wall and rear wall on the base and front flap 302 and rear flap 304, other embodiments such as the ones in FIGS. 1 and 15 also include peripheral walls 208 and peripheral covers 306. The peripheral covers 306 attach to their complementary peripheral walls 208 such that an entire outer surface of the bag can be interchangeable and covered with a main cover 300 and peripheral covers 306. In one embodiment, the sets of complementary retention elements include a first portion of the complementary retention element and a second portion of the complementary retention element such that first portion of the complementary retention element is coupled to the base, and the second portion of the complementary retention element is coupled to the cover. The sets of complementary retention elements is removably attaching the base to the cover and the cover covers an entire surface area of the base.

In another embodiment as depicted in FIGS. 1 and 17, the interchangeable bag system also includes at least one set of interlocking mechanism 500. The set of interlocking mechanism 500 includes an opening 502 and a complementary interlocking attachment 504 such as a twist-lock or a snap-fit interlocking mechanism. In one particular embodiment, the opening 502 is on the base of the bag close to a top rim of the base 200 whereas the complementary interlocking attachment 504 is located within a similar location on the cover of the interchangeable bag system. In this embodiment, the complementary interlocking attachment 504 is located on an inner face of the cover and is engaged when the complementary interlocking attachment 504 is placed through the opening 502 so that the cover is further secured on the base but not showing from the outside of an assembled bag. In this embodiment, the location of the complementary interlocking attachment 504 and opening 502 close to a top rim or edge of the base and on one wall (either front or rear wall but preferably rear wall) allows the cover to remain securely attached to the base of the bag. The removably couplable retention elements allow a user to open the other side of the bag and access an interior compartment without having the cover detach completely from the base.

In yet another embodiment, the complementary interlocking attachment 500 is located on the rear flap 302 of the cover 300 and when the at least one set of interlocking mechanism 500 is engaged, the rear flap 302 of the cover 300 is securely attached to the base 200 and the front flap 304 is removably couplable to the front wall 204 of the base 200 with the at least one set of complementary retention elements 400. Here, a user can open the front flap 302 to access the interior compartment 206 of the interchangeable bag system 100 while the rear flap 302 remains securely attached to the rear wall 202.

FIG. 14 shows a set of complementary retention element 400 as magnets where the first portion of the complementary retention element 402 is magnet 408 and the second portion of the complementary retention element 404 is a gripper 410. In this embodiment, the set of magnets including a magnet and a gripper are such that the magnet and the gripper are located within the base 200 sandwiched within the peripheral wall 208 while the other sets of retention elements on the front and rear wall of the base and front flap and rear flap of the cover have retention elements on the faces of the base and cover as opposed to sandwiched within a layer of the base and cover.

While FIGS. 14 and 15 show one set of interlocking mechanism 500 as an opening 502 and a complementary interlocking attachment 504, or a twist lock mechanism 506, other embodiments include a twist-lock mechanism, a snap-fit, a hook and eye, a buckle set, a clap set, a latch set, a latch and a lock and/or a combination thereof.

In some embodiments, the interchangeable bag system includes a rigid or hard shell base and cover whereas in other embodiments, the interchangeable bag system is made of soft components such as fabric, plastic, leather, polymers or any combination thereof.

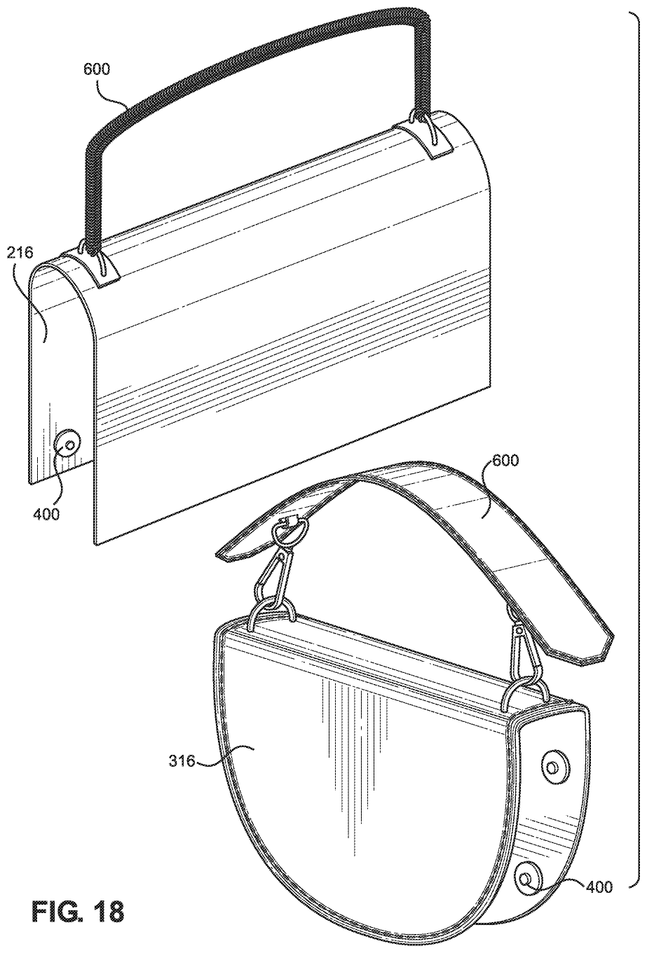

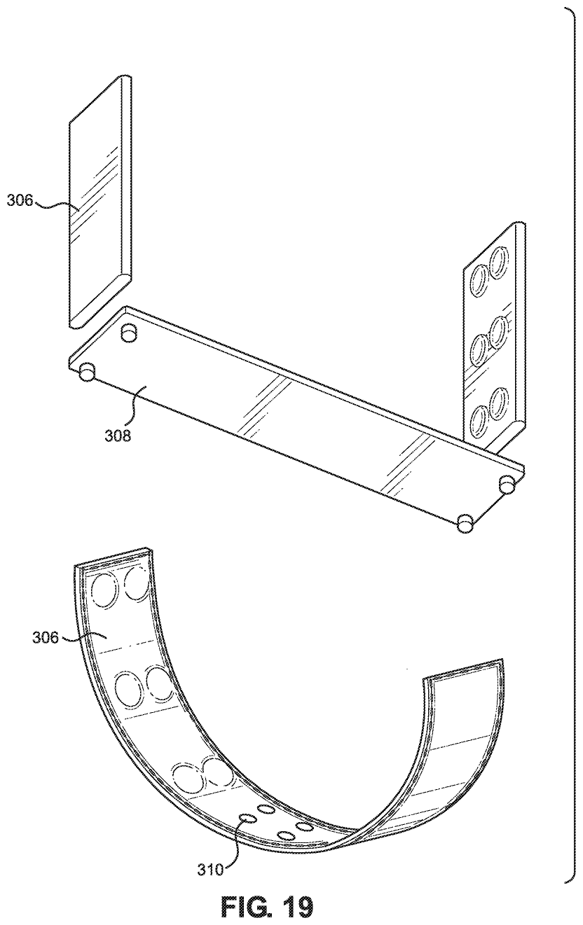

FIGS. 1, 16 and 18 show various embodiments of an interchangeable handle 600 removably coupled to either the base or the cover. In some embodiments, the interchangeable handle 600 is coupled to the base thanks to complementary attachments on the base and the handle while in other embodiments, the interchangeable handle 600 is coupled to the cover or peripheral covers thanks to complementary attachments on the cover and the handle. In other embodiments, the cover, peripheral cover, base and peripheral walls include attachments adapted to receive and interchangeable handle 600 and the user can choose the type of interchangeable handle 600 and where to attach it on the interchangeable bag system.

In one embodiment, the interchangeable handle 600 is a handle system including attachments to attach onto the interchangeable bag system, the removable handle and a removable cover adapted to attach to the removable handle. In this embodiment, the user can change the handle and/or change the cover of the removable handle by attaching a cover to the removable handle just as they would with the cover and the base of the interchangeable bag system.

In some embodiments, the handle 600 or interchangeable handle 600 can be a leather and/or synthetic leather handles, fabric handles, a chain, wooden handles, metal handles, crocheted handles, straw handles, webbing, rope handles, soft cord handles, thread and/or yarn handles, beaded handles, ribbon handles, plastic handles, braided handles, shoulder handles, top handles, long and medium strap handles or an attachment allowing the user to wear the bag around their waist and/or a combination thereof.

In another embodiment, the interchangeable bag system 100 also includes one, two or more legs coupled to a bottom portion of the cover 308 or a bottom portion of the base 210 such that the system can rests on an external surface. Where the legs 610 are attached to the cover, the base does not include any legs 610. However, where the legs are coupled to the base and specifically to a bottom portion of the base 210, the bottom portion of the cover also includes openings 310 adapted to allow the legs 610 coupled to the base to come through the openings 310 such that the entire interchangeable bag system can rest on a surface.

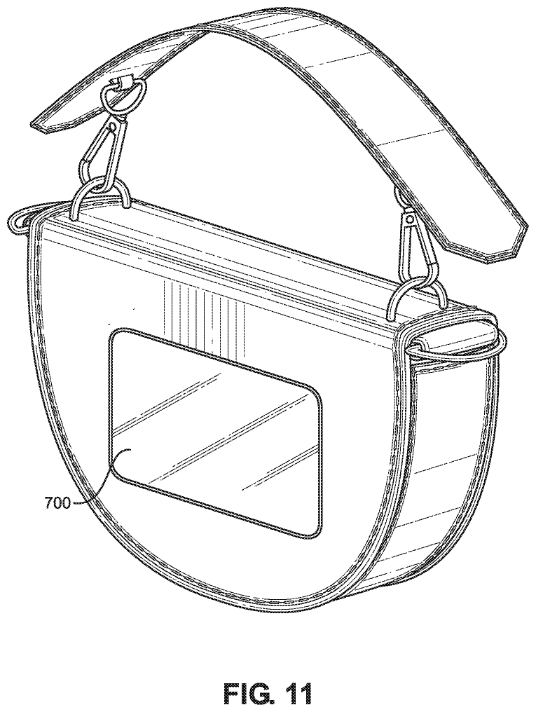

In some embodiments, the interchangeable bag system 100 has a cover which includes an electronic screen 700. In some embodiments, the electronic screen is a touch screen facing outwardly and a user can connect a remote mobile phone or a remote tablet to the touch screen. In this particular embodiment, the screen on the cover of the interchangeable bag system is adapted to mirror a content displaying on the remote mobile phone or the remote tablet. In other embodiments, the electronic screen 700 is an electronic display such as an LED screen, LCD, PDP, OLED, electronic paper E-ink or any equivalent screens. The screen 700 can be a portion of the cover as shown in FIG. 11 or can cover the entire surface area of a cover 300, and/or peripheral covers 306.

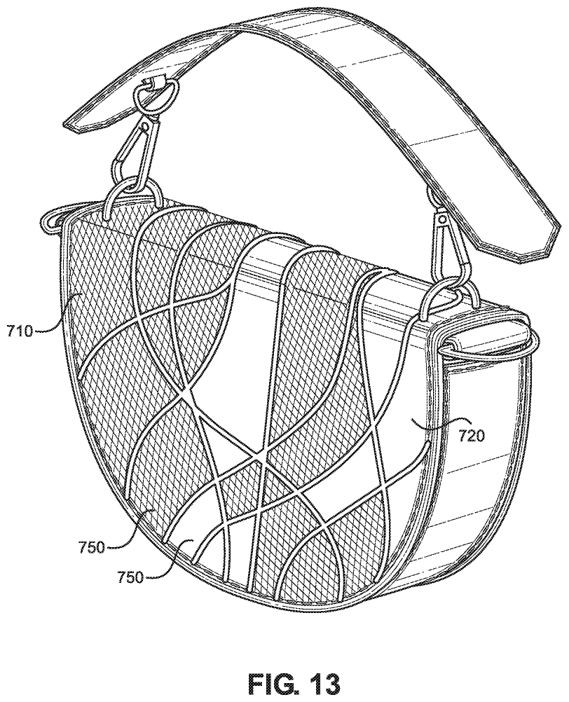

In another embodiment, the interchangeable bag system 100 has a cover which includes at least one speakerphone 710 connectable to an external device and such that a user can select a music from the external device and the music plays on the cover speakerphone. In some embodiments such as the one show in FIG. 13, the cover can include both a screen and a speakerphone interlaced on the cover 750. In other embodiments, the cover can include a speakerphone and a screen separately or together where the speakerphone is a portion of the electronic screen hardware. In yet another embodiment, the interchangeable bag system 100 includes on the cover an electronic screen and a speakerphone connectable to an external device and such that a user can select a music and a screen design from the external device and the music plays on the cover speakerphone and the electronic screen displays an image or a video selected from the external device. The music and images on the screen are adapted to sync via the external device.

In yet another embodiment, the interchangeable bag system 100 further includes a global positioning system 800. In one embodiment the GPS 800 is coupled to the base 200 and is adapted to connect to an external device such that a user can locate a position of the interchangeable bag system 100 if the bag is misplaced or stolen. The GPS is charged with either a cord that connects to the base of the bag, with a remote wireless charging device, electronic retention elements, a charger built-in within the base, solar panels connected to the interchangeable bag system 100 or a combination thereof.

In some embodiments, the base and the cover are complementary spherical, rectangular, semi-circular, heart-shaped, bucket-shaped, hat boxed shape and/or any other polygonal shape.

The present disclosure is also embodied in a method of changing an outer look of an interchangeable bag including the steps of attaching an interchangeable bag cover to an interchangeable bag base by securing a portion of the interchangeable bag cover to a portion of interchangeable bag base with an interlocking mechanism, placing the interchangeable bag cover on the interchangeable bag base such that the cover remains secured to the base with at least one set of retention elements such that the bag cover remains securely attached to one side of the bag base, and the bag cover is removably coupled to another side of the bag base, and attaching a handle to the interchangeable bag.

In other embodiments, the outer look of an interchangeable bag can also include changing the look and appearance of the handle by either changing the handle 600 and attaching a different handle to the handle attachments located on the base of the cover of the bag or the handle can be further changed by attaching a handle cover onto the handle.

A user can change at least one side of the interchangeable bag by attaching a side cover onto a side portion of the bag base.

In another embodiment, the method also includes the steps of providing an electronic screen on the bag where a user can connect a remote device such as a mobile phone or tablet to the interchangeable bag electronic screen and change a display of the electronic screen.

In yet another embodiment, the method also includes the steps of securing the bag cover to the bag base by controlling a set of electronic retention elements via a remote device such as a mobile phone or tablet.

In another embodiment, the method also includes the steps providing the interchangeable bag with a global positioning system and locating a position of the interchangeable bag by connecting a remote device such as a mobile phone or tablet to the interchangeable bag global positioning system.

In an alternative embodiment, the method also includes the steps of providing a speakerphone the bag where a user can connect a remote device such as a mobile phone or tablet to the interchangeable bag speakerphone and play music on the bag's speakerphone.

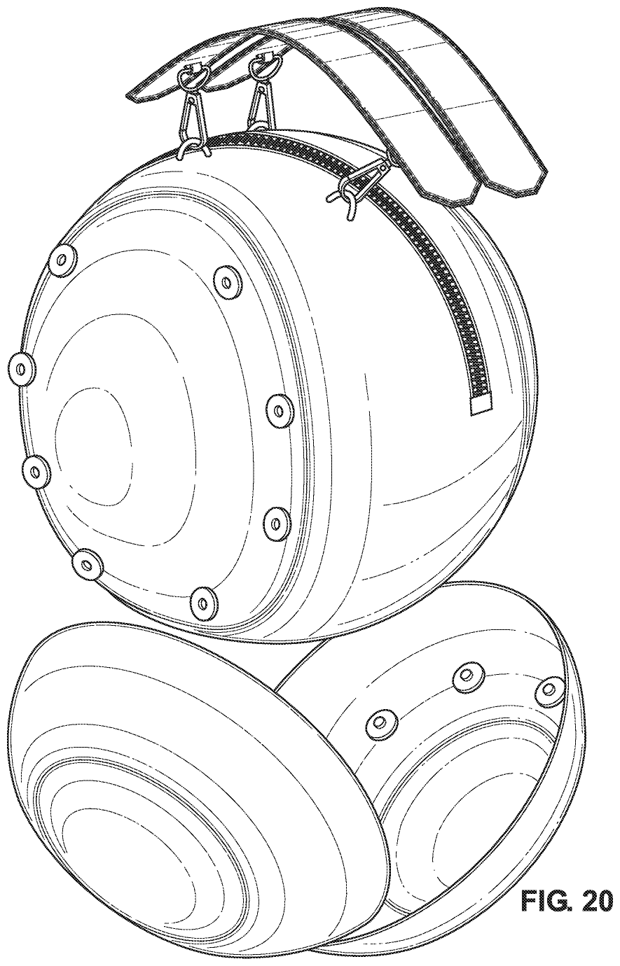

Referring to FIG. 20, in one embodiment, the base 200 and cover 300 are in the shape of a sphere. In this embodiment, the main base is a sphere with one or more sets of complementary retention elements. The complementary retention elements include two portions: a first portion of the complementary retention element 402 which is coupled to the base 200 and a second portion of the complementary retention element 404 which is coupled to the cover. While the first portion is on the base and the second portion is on the cover in this embodiment, in other embodiments, the first portion can be coupled to the cover while the second portion of the complementary retention element can be coupled to the base. In yet another embodiment, the base can be coupled to both a first portion of the complementary retention element 402 and a second portion of the complementary retention element 404 and the cover is also coupled to the mirror complementary portions of the retention elements such that both the base and the cover are both coupled to both portions of the retention elements and the other side of the complementary retention element is coupled to the cover and the base respectively.

In this spherical embodiment, the base 200 is two half spheres connected at a bottom section of the sphere with an expanding material such as fabric or other expanding materials, and the base when opened forms an interior compartment 206 of the interchangeable bag system where a user can place their belongings. A first portion of one or more sets of complementary retention elements 400 are coupled to the outer facing side of the base or two half spheres in this particular embodiment. The second portion of the one or more sets of complementary retention elements 400 are coupled to an inner facing side of the cover or two half spheres. While in this embodiment, the sets of complementary retention elements are placed on the outer facing side of the base and the other complementary portion is placed on the inner facing side of the cover, the sets of complementary retention elements can be located within the base and the cover such that the sets of complementary retention elements are sandwiched within the base and the cover and are not readily visible to a user. So long as a first portion of the sets of complementary retention elements is coupled to the base and a second portion of the sets of complementary retention elements is coupled to the cover and adapted to attach the cover to the base of the bag.

In some embodiments, the interchangeable bag system does not include peripheral walls, peripheral covers or interlocking mechanism. In these embodiments, the bag includes a base having a rear wall and a front wall opposite the rear wall where the base forms an interior compartment of the interchangeable bag system, a cover including a rear flap and a front flap and at least one set of complementary retention elements. The set of complementary retention elements includes a first portion of the complementary retention element and a second portion of the complementary retention element where the first portion of the complementary retention element is coupled to the base and the second portion of the complementary retention element is coupled to the cover and where the set of complementary retention elements is removably attaching the base to the cover. In this embodiment, a user can change an outer look of a bag by removing a currently attached cover and placing a different cover on the base of the bag system. In these embodiments, the cover covers an entire surface area of the base or only a portion of the base if the user wishes to only use a portion of the cover.

In one embodiment of the present disclosure, the system is an interchangeable bag system comprising a base having an outer surface, a cover having an inner surface, where the outer surface of base is couplable to the inner surface of cover, and further comprises at least one set of complementary retention elements attachable to the base and the cover.

In some embodiments, the retention elements are sets of complementary magnets, while in other embodiments, they are sets of hooks and loops, or lace to be placed in adapted openings.

FIG. 1, through 16 depict various embodiments of an interchangeable bag system. The systems in these figures show a base, a cover, retention elements on the outer surface of the base and inner surface of the cover. In some embodiments, the retention element is a set of complementary magnets, with one side on the inner surface of the cover and the other side on the outer surface of the base. When the cover is placed on the base of the bag system, the magnets on each side of the base and cover attach and only the cover is visible from an outside perspective. In other embodiments, the cover goes over the top of the base, thereby covering the entire look of the bag. The cover is interchangeable.

In some embodiments, the cover is a full rectangular hard-shell piece which covers the entire base. In this specific embodiment, only the sides of the bag and bottom of the bag from the base of the bag system are visible, the rest of the bag system showing is the cover. In other embodiments, the cover does not fully cover the base, and is a polygonal hiding some portions of the cover and showing other portions of the bag, thereby creating a different look and feel of the bag.

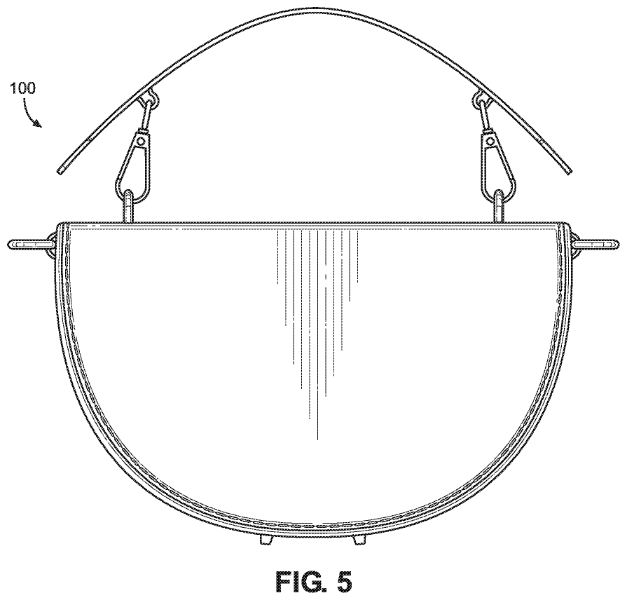

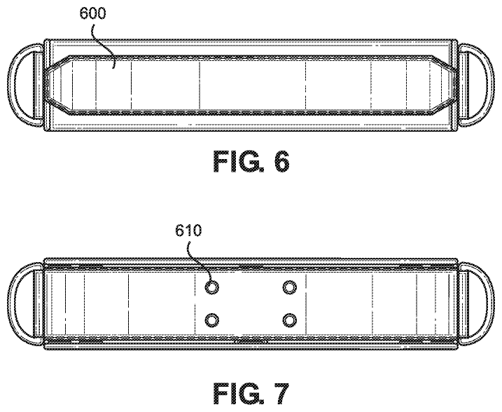

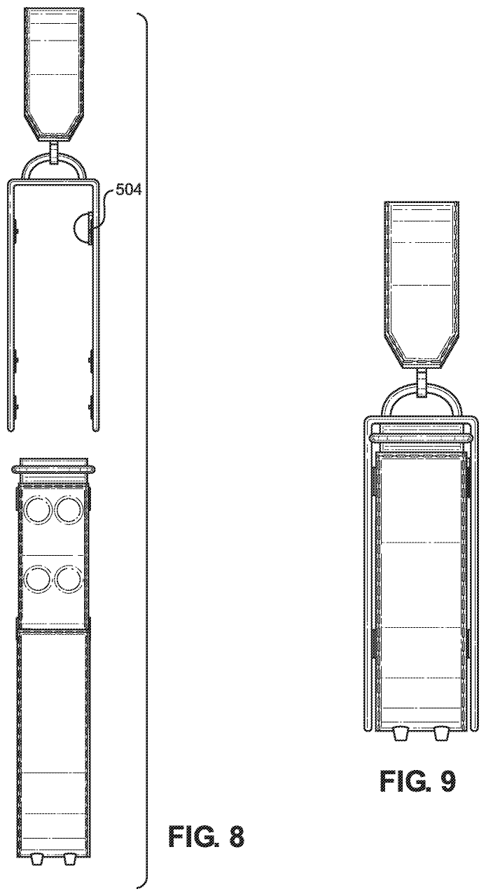

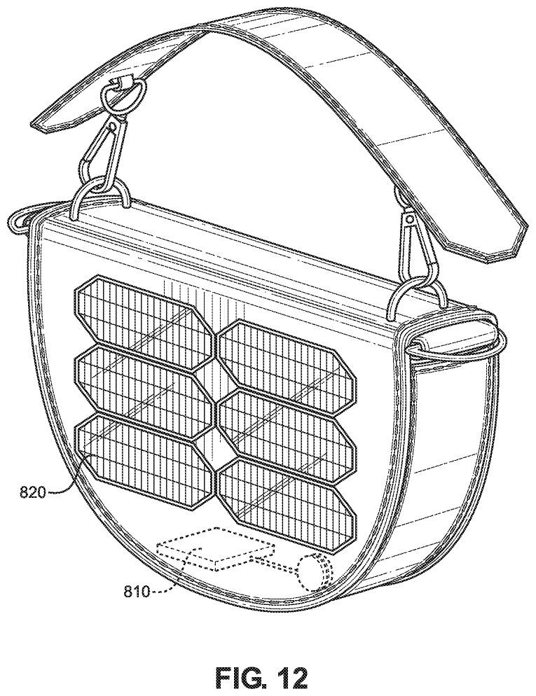

While FIGS. 1 through 16 show round magnetic retention elements to couple the base of the bag system to the cover and a plurality of sets of retention element, other embodiments include a different shape of magnetic retention element or different kinds of retention elements. Other embodiments include different sets of complementary retention elements such as a hook and loop, lace adapted to attach to complementary openings, velcro, or any other mechanical retention elements or a combination thereof.

In some embodiments, the interchangeable bag system includes a coupling mechanism within the side of the base and sides of the bottom cover, sewn and sandwiched within the elements themselves. In some embodiments, the coupling and retention elements are visible elements attached to the bag base, bag cover and bag holders while in others, it's magnetic elements within the bag not visible to the user and strong enough to attach the elements together, able to be carried around and able to carry substantial load within the bags without falling apart.

In another embodiment, the base and sides of the bag all have interchangeable covers

In some embodiments, the base and covers are a hard-shell interchangeable bag system. In other embodiments, the interchangeable bag system comprises a hard-shell base and/or cover while other embodiments comprise fluid like materials such as soft fabrics, leathers or other composite materials.

In some embodiments, the cover of the interchangeable bag system becomes an integral part of the bag such as a lid of the bag, attached to only one side of the base of the interchangeable bag system.

In some embodiments, the straps or handles of the interchangeable bag system are part of the base, part of the cover, or removeable and versatile elements capable of being changed as well, and either couplable to the base or the cover of the bag system. In one embodiment of the disclosure, continuous strips of hook and loop type fastening material are provided on either side of the base and cover. These strips mate with corresponding strips provided on the inner surface of cover to fasten the cover in place. The strips on base also mate with one another to seal the base when it is removed from the outer cover. Lifting straps attached to the base or to the cover are provided to facilitate removal of the cover from the base.

In some embodiments, the bag handles 600 are interchangeable handles as well. In some cases, the handle connects to the bag base 200 while in other embodiments, the bag handle connects to the bag cover 300. In some embodiments, the bag handle can protrude through the bag cover, and shows separately when the bag cover is coupled to the bag base. In some embodiments, the handle is asymmetric, while in other embodiments, the handle is symmetric and can take any form or artistic shape.

In one embodiment, the interchangeable bag system also includes a fingerprint unlocking device such that a user can unlock the bag system through fingerprint recognition. This fingerprint unlocking device is coupled to either the base, the cover, and/or the handle and allows a user to open the bag system to access the interior compartment and also to be able to change the covers and handles on the bag system.

As mentioned above, other embodiments and configurations may be devised without departing from the spirit of the invention and the scope of the appended claims.

1. An interchangeable bag system comprising:
a) a base having a rear wall and a front wall opposite the rear wall wherein the base forms an interior compartment of the interchangeable bag system;
b) a cover including a rear flap and a front flap;
c) at least one set of complementary retention elements including a first portion of the complementary retention element and a second portion of the complementary retention element wherein the first portion of the complementary retention element is coupled to the base and the second portion of the complementary retention element is coupled to the cover and wherein the at least one set of complementary retention elements is removably attaching the base to the cover and wherein the cover covers an entire surface area of the base;
d) at least one set of interlocking mechanism comprising an opening located on the base and a complementary interlocking attachment located on the rear flap of the cover wherein when the at least one set of interlocking mechanism is engaged, the rear flap of the cover is securely attached to the base and the front flap is removably couplable to the front wall of the base with the at least one set of complementary retention elements, and wherein when a user opens the front flap to access the interior compartment of said interchangeable bag system, the rear flap remains securely attached to the rear wall.

2. The interchangeable bag system of claim 1 wherein:
a) the base further comprises a peripheral wall connecting said rear wall to said front wall;
b) the cover further comprises at least one peripheral cover;
c) the first portion of the at least one set of complementary retention element is coupled to the peripheral wall and the second portion of the at least one set of complementary retention element is coupled to the at least one peripheral cover wherein the at least one peripheral cover is removably couplable to peripheral wall.

3. The interchangeable bag system of claim 2 wherein the at least one set of complementary retention elements is a set of magnets including a magnet and a gripper wherein at least one of the magnet and the gripper is located within said base sandwiched within at least one of the front wall, rear wall and the peripheral wall.

4. The interchangeable bag system of claim 1 wherein the at least one set of complementary retention elements is at least one of a complementary set of magnets, a complementary set of hooks and loops, a complementary set of lace and loops, a complementary set of snap-on attachments, a complementary set of a latch and lock, a complementary set of buttons, a complementary set of twist-and-lock and opening, a complementary set of hook and eye, a tuck lock, a release buckle, a clasp, a latch, a zipper and a pin.

5. The interchangeable bag system of claim 1 wherein the at least one set of interlocking mechanism is at least one of a twist-lock mechanism, a snap-fit, a hook and eye, a buckle set, a clap set, a latch set, and a latch and a lock.

6. The interchangeable bag system of claim 1 further comprising an interchangeable handle removably coupled to either the base or the cover.

7. The interchangeable bag system of claim 1 further comprising two or more legs coupled to a bottom side of the cover such that the system rests on a surface.

8. The interchangeable bag system of claim 1 further comprising two or more legs coupled to a bottom portion of the base and one or more openings on a bottom side of the cover adapted to fit said legs through said one or more openings such that the interchangeable bag system rests on a surface.

9. The interchangeable bag system of claim 1 wherein said at least one set of complementary retention elements are electronic retention elements controllable via an external device such as a mobile phone, a tablet or a remote controller.

10. The interchangeable bag system of claim 9 further comprising a battery adapted to be charged by a remote charging station and wherein the battery is adapted to charge at least one of said electronic retention elements, a speakerphone coupled to the interchangeable bag system, an electronic screen coupled to the interchangeable bag system, and a global positioning system coupled to the interchangeable bag system.

11. The interchangeable bag system of claim 9 wherein the cover further comprises a solar panel adapted to be charged by a solar power and wherein the at least one solar panel is adapted to charge at least one of said electronic retention elements, a speakerphone coupled to the interchangeable bag system, an electronic screen coupled to the interchangeable bag system, a battery coupled to the interchangeable bag system, and a global positioning system coupled to the interchangeable bag system.

12. The interchangeable bag system of claim 1 wherein the cover further comprises a touch screen facing outwardly wherein a user can connect a remote mobile phone or a remote tablet to the touch screen and wherein the screen on the cover of the interchangeable bag system is adapted to mirror a content displaying on the remote mobile phone or the remote tablet.

13. The interchangeable bag system of claim 1 wherein the cover further comprises at least one speakerphone connectable to an external device and such that a user can select a music from the external device and the music plays on the cover speakerphone.

14. The interchangeable bag system of claim 1 further comprising a global positioning system adapted to connect to an external device such that a user can locate a position of said interchangeable bag system.

15. The interchangeable bag system of claim 1 wherein the base and the cover are spherical, rectangular, semi-circular, heart-shaped, bucket-shaped or polygonal.

16. A method of changing an outer look of an interchangeable bag comprising the steps of:
a) attaching an interchangeable bag cover to an interchangeable bag base by securing a portion of the interchangeable bag cover to a portion of interchangeable bag base with one or more sets of complementary retention elements;
b) placing the interchangeable bag cover on the interchangeable bag base wherein the cover remains secured to the base with at least one set of retention elements, and wherein the bag cover remains securely attached to at least one side of the bag base, and the bag cover is removably coupled to an opposite side of the bag base; and
c) attaching a removable handle to the interchangeable bag.

17. The method of claim 16 wherein the handle can be further changed by attaching a handle cover onto the handle.

18. The method of claim 16 further comprising the steps of providing an electronic screen on the bag wherein a user can connect a remote device such as a mobile phone or tablet to the interchangeable bag electronic screen and change a display of the electronic screen.

19. The method of claim 16 further comprising the steps of securing the bag cover to the bag with a set of electronic retention elements and by controlling the set of electronic retention elements via a remote device such as a mobile phone or tablet.

20. The method of claim 16 further comprising the steps of providing the interchangeable bag with a global positioning system and locating a position of the interchangeable bag by connecting a remote device such as a mobile phone or tablet to the interchangeable bag global positioning system.
